(19) United States
(12) Patent Application Publication
(10) Pub. No.: US 2007/0224113 A1
(43) Pub. Date: Sep. 27, 2007

(54) Process for Preparing Nano Size Zeolites

(76) Inventors: Richard R. Willis, Cary, IL (US); Dorothy E. Kuechl, Des Plaines, IL (US); Annabelle I. Benin, Oak Forest, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/688,267

(22) Filed: Mar. 20, 2007

Related U.S. Application Data
(60) Provisional application No. 60/785,932, filed on Mar. 24, 2006.

(51) Int. Cl. C01B 39/00; C01B 33/36

(52) U.S. Cl. 423/700; 423/704; 423/705; 423/708

(57) ABSTRACT

A process has been developed to synthesize various zeolites with nano size crystals. The process involves forming an aluminosilicate initiator which exhibits the Tyndall effect. This initiator is then mixed with a clear solution comprising reactive sources of Al, Si, M and R plus water. M is an alkali or alkaline earth metal while R is an organoammonium compound. The resultant reaction mixture is reacted at a temperature and for a time sufficient to produce a zeolite such as zeolite Y with average crystallite size less than 500 nm.

### CROSS REFERENCE TO RELATED APPLICATION

This application claims priority from Provisional Application Ser. No. 60/785,932 filed Mar. 24, 2006, the contents of which are hereby incorporated by reference in its entirety.

### BACKGROUND OF THE INVENTION

Nano size zeolites are those whose crystal size is less than 1000 nm and usually less than 500 nm. Zeolites comprised of nano-crystals will have an increased surface area which should give rise to increased activity and selectivity in the particular process in which they are used. Increased activity will most probably be owing to increased intracrystalline diffusion and greater percentage of surface atoms.

There are reports in the literature of the synthesis of nano-crystalline zeolites. For example, R. Van Grieken et al. in Microporous and Mesoporous Materials, Vol. 39 (2000), 135-147 describe the synthesis of ZSM-5 with crystals in the range of 10-100 mu. B. J. Schoeman et al. in Zeolites, Vol. 14 (1994), 110 discloses the preparation of zeolite Y having an average crystal size of less than 150 nm. The problems with these two preparations are that the reagent costs are significantly higher than the standard reagents and for the zeolite Y, yield is poor. Accordingly, there is a need for a process to synthesize nano-crystalline zeolites over a wide Si/Al range.

### SUMMARY OF THE INVENTION

One embodiment of the invention is a process for preparing zeolites having an average crystallite size of less than 500 nm, the zeolite having an empirical formula of:

(AlₓSi₁₋ₓ)O₂

where Al and Si are framework elements present as tetrahedral oxide units, “x” has a value from greater than 0 to about 0.5; the process comprising mixing an initiator with a reaction solution to provide a reaction mixture, reacting the reaction mixture at a temperature of about 25° C. to about 200° C. for a time of about 1 hr to about 40 days to produce the zeolite, the initiator having a composition represented by an empirical formula of:

Al₂O₃:aSiO₂:bM_{2/m}O:cH₂O

where “a” has a value from about 4 to about 30, “b” has a value from about 4 to about 30, and “c” has a value from about 50 to about 500, “m” is the valence of M and has a value of +1 or +2 and M is a metal selected from the group consisting of alkali metals, alkaline earth metals and mixtures thereof; the initiator prepared by mixing reactive sources of Al, Si and M plus water and then aging the initiator at a temperature of about 0° C. to about 100° C. for a time sufficient for the initiator to exhibit the Tyndall effect; the reaction solution having a composition represented by an empirical formula of:

Al₂O₃:dSiO₂:eM_{2/m}O:fR_{2/p}O:gH₂O

where “d” has a value from about 4 to about 30, “e” has a value from about 4 to about 30, “f” has a value from 0 to about 30 and “g” has a value from about 5 to about 500, “p” is the valence of R and has a value of +1 or +2, R is an organoammonium cation selected from the group consisting of quaternary ammonium ions, protonated amines, protonated diamines, protonated alkanolamines, diquaternary ammonium ions, quaternized alkanolamines and mixtures thereof; the reaction solution formed by combining reactive sources of Al, Si, M and R plus water.

Additional objects, embodiments and details of this invention can be obtained from the following description of the invention.

### DETAILED DESCRIPTION OF THE INVENTION

One object of the invention is the preparation of zeolites characterized in that the average crystallite size is less than about 500 nm and preferably less than 300 nm. By crystallite is meant individual crystals as opposed to agglomerated crystals which are usually referred to as particles. Generally the zeolites which can be synthesized as nano-crystallite are any of the zeolites having a composition represented by the empirical formula:

(AlₓSi₁₋ₓ)O₂

where Al and Si are framework elements present as tetrahedral oxide units and “x” has a value from greater than 0 to about 0.5. Specific structure types of zeolites which can be prepared include but are not limited to zeolite Y, zeolite X, structure types BEA, FAU, MFI, MEL, MTW, MOR, LTL, LTA, EMT, ERI, FER, MAZ, MEI, TON, and MWW.

One necessary part of the process of the invention is an initiator. The initiator is a concentrated, high pH aluminosilicate solution which can be clear or cloudy and has a composition represented by an empirical formula of:

Al₂O₃:aSiO₂:bM_{2/m}O:cH₂O

where “a” has a value from about 4 to about 30, “b” has a value from about 4 to about 30, and “c” has a value from about 50 to about 500, “m” is the valence of M and has a value of +1 or +2 and M is a metal selected from the group consisting of alkali metals, alkaline earth metals and mixtures thereof with preferred metals being lithium, sodium, potassium and mixtures thereof. The initiator is prepared by mixing reactive sources of Al, Si and M plus water.

Accordingly, the aluminum sources include but are not limited to, aluminum alkoxides, precipitated alumina, aluminum hydroxide, aluminum salts and aluminum metal. Specific examples of aluminum alkoxides include, but are not limited to aluminum orthosecbutoxide, and aluminum orthoisopropoxide. Sources of silica include but are not limited to tetraethylorthosilicate, fumed silicas, precipitated silicas and colloidal silica. Sources of the M metals include but are not limited to the halide salts, nitrate salts, acetate salts, and hydroxides of the respective alkali or alkaline earth metals. When M is sodium, preferred sources are sodium aluminate and sodium silicate. The sodium aluminate is prepared in situ by combining gibbsite with sodium hydroxide. Once the initiator is formed it is aged at a temperature of about 0° C. to about 100° C. for a time sufficient for the initiator to exhibit the Tyndall effect. Usually the time varies from about 1 hr to about 14 days and preferably from about 12 hours to about 10 days.

A second component of the process of the invention is a reaction solution from which the desired zeolite will be synthesized. This solution will have a composition represented by an empirical formula of:

Al₂O₃:dSiO₂:eM_{2/m}O:fR_{2/p}O:gH₂O

where “d” has a value from about 4 to about 30, “e” has a value from about 4 to about 30, “f” has a value from 0 to about 30 and “g” has a value from about 5 to about 500, “p” is the valence of R and has a value of +1 or +2, R is an organoammonium cation selected from the group consisting of quaternary ammonium ions, protonated amines, protonated diamines, protonated alkanolamines, diquaternary ammonium ions, quaternized alkanolamines and mixtures thereof; the reaction solution formed by combining reactive sources of Al, Si, M and R plus water. The sources of aluminum, silicon and M are as described above, while the sources of R include but are not limited to hydroxide, chloride, bromide, iodide and fluoride compounds. Specific examples include without limitation ethyltrimethylammonium hydroxide (ETMAOH), diethyldimethylammonium hydroxide (DEDMAOH), propylethyldimethylammonium hydroxide (PEDMAOH), trimethylpropylammonium hydroxide, trimethylbutylammonium hydroxide (TMBAOH), tetraethylammonium hydroxide, hexamethonium bromide, tetramethylammonium chloride, N,N,N,N′,N′,N′-hexamethyl 1,4 butanediammonium hydroxide and methyltriethylammonium hydroxide. The source of R may also be neutral amines, diamines, and alkanolamines. Specific examples are triethanolamine, triethylamine, and N,N,N′,N′ tetramethyl-1,6-hexanediamine.

A reaction mixture is now formed by mixing the initiator and reaction solution. Usually the initiator is slowly added to the reaction solution and stirred for an additional period of time to ensure homogeneity. The resultant reaction mixture is now charged to an autoclave and reacted under autogenous pressure at a temperature of about 25° C. to about 200° C. for a time of about 1 hr to about 40 days. Reaction can be carried out either with or without stirring. After reaction is complete, the solid zeolite is separated from the reaction mixture by means well known in the art such as filtration or centrifugation, washed with deionized water and dried in air at ambient temperature up to about 100° C.

The crystallites obtained by the above described process are characterized in that they have an average crystallite size of less than 500 mu and preferably less than 300 mu. As stated above, what is meant by crystallite is individual crystals which can agglomerate into larger particles. The exchangeable cations M and R can be exchanged for other desired cations and in the case of R can be removed by heating to provide the hydrogen form of the zeolites. These zeolites can be used in various hydrocarbon conversion processes or as adsorbents.

In order to more fully illustrate the invention, the following examples are set forth. It is to be understood that the examples are only by way of illustration and are not intended as an undue limitation on the broad scope of the invention as set forth in the appended claims.

### EXAMPLE 1

A container containing 1784 g of a 50 wt.-% NaOH solution was heated and to it there were added 313 g of gibbsite alumina. The container was removed from the heat and to it there were added 2206.6 g of deionized (DI) water and the sodium aluminate solution cooled to room temperature. In a separate container, 2206.6 g of DI water was added to 6604 g of sodium silicate and while stirring the sodium aluminate solution was added. The resultant initiator was aged overnight at 50° C. The initiator had an empirical formula of:

Al₂O₃:16SiO₂:16Na₂O:238H₂O.

A reaction solution was prepared by mixing tetraethylorthosilicate (TEOS) with aluminum tri-sec-butoxide and diethyldimethylammonium (DEDMA) hydroxide to provide a reaction solution having an empirical formula of:

Al₂O₃:10.26SiO₂:2.74(DEDMA)₂O:230H₂O

The initiator was slowly added to the reaction solution with stirring. The resultant reaction mixture was stirred, transferred to an autoclave where it was reacted at 100° C. for 4 days. After cooling to room temperature, the zeolite Y was separated from the liquid by centrifugation, washed and dried. The zeolite Y was found to have a Si/Al of 3.1 and an average crystallite size of less than 200 nm.

1. A process for preparing zeolites having an average crystallite size of less than 500 nm, the zeolite having an empirical formula of:
(AlₓSi₁₋ₓ)O₂
where Al and Si are framework elements present as tetrahedral oxide units, “x” has a value from greater than 0 to about 0.5; the process comprising mixing an initiator with a reaction solution to provide a reaction mixture, reacting the reaction mixture at a temperature of about 25° C. to about 200° C. for a time of about 1 hr to about 40 days to produce the zeolite, the initiator having a composition represented by an empirical formula of:
Al₂O₃:aSiO₂:bM₂/mO:cH₂O
where “a” has a value from about 4 to about 30, “b” has a value from about 4 to about 30, and “c” has a value from about 50 to about 500, “m” is the valence of M and has a value of +1 or +2 and M is a metal selected from the group consisting of alkali metals, alkaline earth metals and mixtures thereof; the initiator prepared by mixing reactive sources of Al, Si and M plus water and then aging the initiator at a temperature of about 0° C. to about 100° C. for a time sufficient for the initiator to exhibit the Tyndall effect; the reaction solution having a composition represented by an empirical formula of:
Al₂O₃:dSiO₂:eM₂/mO:fR₂/pO:gH₂O
where “d” has a value from about 4 to about 30, “e” has a value from about 4 to about 30, “f” has a value from 0 to about 30 and “g” has a value from about 5 to about 500, “p” is the valence of R and has a value of +1 or +2, R is an organoammonium cation selected from the group consisting of quaternary ammonium ions, protonated amines, protonated diamines, protonated alkanolamines, diquaternary ammonium ions, quaternized alkanolamines and mixtures thereof; the reaction solution formed by combining reactive sources of Al, Si, M and R plus water.

2. The process of claim 1 where M is selected from the group consisting of lithium, sodium, and potassium.

3. The process of claim 1 where the zeolite has an average crystallite size of less than 300 nm.

4. The process of claim 1 where the zeolite has the structure type BEA, FAV, MFI, MEL, MTW, MOR, LTL, LTA, EMT, ERI, FER, MAZ, MEI, TON and MWW.

5. The process of claim 4 where the zeolite has the structure of zeolite Y or zeolite X.

6. The process of claim 1 where the aluminum source is selected from the group consisting of aluminum alkoxides, precipitated alumina, aluminum hydroxide, aluminum salts, aluminum metal and mixtures thereof.

7. The process of claim 1 where the silica source is selected from the group consisting of tetra-ethylorthosilicate, fumed silicas, precipitated silicas, colloidal silica and mixtures thereof.

8. The process of claim 1 where the aging time of the initiator varies from about 1 hour to about 14 days.

9. The process of claim 1 where the source of the M metals is selected from the group consisting of the halide salts, nitrate salts, acetate salts, hydroxides and mixtures thereof.
